(19) United States
(12) Patent Application Publication
(10) Pub. No.: US 2026/0330758 A1
(43) Pub. Date: Oct. 22, 2026

(54) MODELING APPARATUS AND MODELING METHOD

(71) Applicant: DELTA ELECTRONICS, INC., Taoyuan City (TW)

(72) Inventors: Jian-Jang LAI, Taoyuan City (TW); Zhi-Hao KANG, Taoyuan City (TW); Wen-Hao CHANG, Taoyuan City (TW)

(21) Appl. No.: 19/245,419

(22) Filed: Jun. 23, 2025

(30) Foreign Application Priority Data
Apr. 21, 2025 (TW) 114115041

(51) Int. Cl. G06T 17/00; G06T 7/13; G06T 7/62; G06V 10/141; G06V 10/28

(52) U.S. Cl. CPC G06T 17/00; G06T 7/13; G06T 7/62; G06V 10/141; G06V 10/28

(57) ABSTRACT

A modeling apparatus and a modeling method are provided. The apparatus obtains a first image and a second image captured from a viewing angle of an object. The apparatus captures a contour of the object based on the first image. The apparatus captures an appearance of the object from the second image based on the contour. The apparatus calculates a size of the object based on multiple reference points in the images. The apparatus generates a three-dimensional model of the object based on the contour, the appearance, and the size of the object.

### RELATED APPLICATIONS

This application claims priority to Taiwan Application Serial Number 114115041, filed on Apr. 21, 2025, which is herein incorporated by reference in its entirety.

### BACKGROUND

### Field of Invention

The present disclosure relates to a modeling apparatus and a method. More particularly, the present disclosure relates to a modeling apparatus and a method based on multiple images.

### Description of Related Art

With the increasing demand for smart manufacturing and intelligent factories, the demand for digital twin systems has emerged. The 3D model virtualization of the real environment is a necessary technology for building the system. However, in the practice of factory manufacturing, it is difficult to directly obtain the model files of the processed products due to the confidentiality of the processed products and the difficulty of obtaining them.

For the foregoing reason, there is a need to provide a convenient and highly accurate modeling technology to solve the problems of the prior art.

### SUMMARY

One aspect of the present disclosure provides a modeling apparatus, which includes a camera and a processor. The camera is configured to capture a first image and a second image of an object at a viewing angle. The processor is electrically connected to the camera, and is configured to perform following operations: capturing a contour of the object according to the first image; capturing an appearance of the object from the second image according to the contour of the object; calculating a size of the object according to the reference points of the first image or the second image; and generating a three-dimensional model of the object according to the contour, the appearance and the size of the object.

Another aspect of the present disclosure provides a modeling method, which is adapted to an electronic device, and steps of the modeling method comprises comprise: obtaining a first image and a second image of an object captured at a viewing angle; capturing a contour of the object according to the first image; capturing an appearance of the object from the second image according to the contour; calculating a size of the object according to the reference points of the first image or the second image; and generating a three-dimensional model of the object according to the contour, the appearance and the size of the object.

It should be understood that the aforementioned general description and the following detailed description are exemplary and explanatory only and are intended to provide further explanation of the present disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 depicts a schematic diagram of a modeling apparatus according to a first embodiment of the present disclosure;

FIG. 2 depicts a schematic diagram showing a use scenario of a modeling apparatus according to some embodiments of the present disclosure;

FIG. 3 depicts a schematic diagram of a backlight image according to some embodiments of the present disclosure;

FIG. 4 depicts a schematic diagram of a fill light image according to some embodiments of the present disclosure;

FIG. 5 depicts a schematic diagram of an adjusted backlight image according to some embodiments of the present disclosure;

FIG. 6 depicts a schematic diagram of an adjusted fill light image according to some embodiments of the present disclosure;

FIG. 7 depicts a schematic diagram of generating a three-dimensional shape based on a size of an object according to some embodiments of the present disclosure;

FIG. 8 depicts a schematic diagram of generating a three-dimensional model based on an appearance of an object according to some embodiments of the present disclosure; and

FIG. 9 depicts a flow chart of a modeling method according to a second embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The terminology used herein is for the purpose of describing particular example embodiments only and is not intended to be limiting of the present disclosure. As used herein, the singular forms “a,” “an” and “the” are intended to include the plural forms as well, unless the context clearly indicates otherwise.

Furthermore, it should be understood that the terms, “comprising”, “including”, “having”, “containing”, “involving” and the like, used herein are open-ended, that is, including but not limited to.

The terms used in this specification and claims, unless otherwise stated, generally have their ordinary meanings in the art, within the context of the disclosure, and in the specific context where each term is used. Certain terms that are used to describe the disclosure are discussed below, or elsewhere in the specification, to provide additional guidance to the practitioner skilled in the art regarding the description of the disclosure.

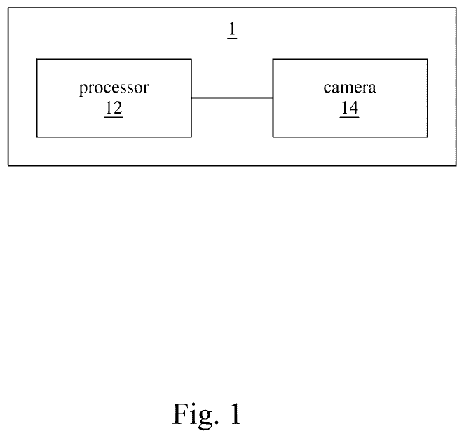

Please refer to FIG. 1, which depicts a schematic diagram of a modeling apparatus 1 according to a first embodiment of the present disclosure. The modeling apparatus 1 includes a processor 12 and a camera 14, where the processor 12 is electrically connected to the camera 14. The modeling apparatus 1 is configured to build a three-dimensional model of an object according to images.

In some embodiments, the processor 12 includes a central processing unit (CPU), a graphics processing unit (GPU), multiple processors, a distributed processing system, an application specific integrated circuit (ASIC), and/or a suitable computing unit.

The camera 14 is configured to capture images of the object. In some embodiments, the camera 14 can be a camera for capturing a planar image and/or a depth camera for capturing a depth image.

In some embodiments, at first, the modeling apparatus 1 is configured to take two images of the object at the same viewing angle, and capture a contour of the object from a first image. Next, the modeling apparatus 1 is configured to capture an appearance of object from a second image according to the contour of the object. Then, the modeling apparatus 1 is configured to calculate an actual size of the object according to a plurality of reference points of the first image or the second image. Finally, the modeling apparatus 1 is configured to generate a three-dimensional model of the object according to the contour, the appearance and the actual size of the object.

Specifically, the camera 14 is configured to capture a first image and a second image of an object at a viewing angle, where one of the first image and the second image includes a plurality of reference points, and the processor 12 is configured to perform following operations: capturing a contour of the object according to the first image; capturing an appearance of the object from the second image according to the contour of the object; calculating a size of the object according to the reference points of the first image or the second image; and generating a three-dimensional model of the object according to the contour, the appearance and the size of the object.

In some embodiments, in order to more easily capture the contour of the object, when capturing the first image, based on the viewing angle of the camera 14, the modeling apparatus 1 provides the backlight behind the object, so that the contour of the object in the first image is clearer.

Specifically, the modeling apparatus 1 further includes a backlight source 16, the backlight source 16 is electrically connected to the processor 12 and is configured to project a backlight towards to the camera 14, where a placement space is formed between the backlight source 16 and the camera 14, and the placement space is configured to accommodate the object. Correspondingly, the operation of capturing the first image of the object further includes: the processor 12 is configured to turn on the backlight source to project the backlight; and when the backlight source projects the backlight, the camera 14 is configured to capture the first image of the object.

In some embodiments, since a shooting environment may not have enough light, in order to more easily capture the appearance of the object, when capturing the second image, based on the viewing angle of the camera 14, modeling apparatus 1 provides a fill light in front of the object to make the appearance of the object in the second image clearer.

Specifically, the modeling apparatus 1 further includes a positive light source 18. The positive light source 18 is electrically connected to the processor, and is configured to project a fill light towards to the object. Correspondingly, the operation of capturing the second image of the object further includes: the processor 12 is configured to turn on the positive light source 18 to project the fill light; and when the positive light source projects 18 projects the fill light, the camera 14 is configured to capture the second image of the object.

In some embodiments, the backlight source 16 and/or the positive light source 18 are a light emitting diode or other light source. In this embodiment, the backlight source 16 and the positive light source 18 are white light sources, so that the camera 14 can capture clearer images.

In some embodiments, since the camera 14 captures a plurality of reference points RP when capturing images, and based on the known distance between the reference points RP, the modeling apparatus 1 is configured to use the number of pixels between the reference points RP in the image to calculate a ratio of the image pixels to the actual distance (i.e., a pixel distance). Accordingly, the modeling apparatus 1 can be configured to calculate the actual size of the object being measured in the image.

Specifically, the operation of the processor 12 to calculate the size of the object further includes: calculating a pixel distance according to an actual distance between the reference points and a number of pixels between the reference points in the first image or the second image; and calculating the size of the object according to the pixel distance.

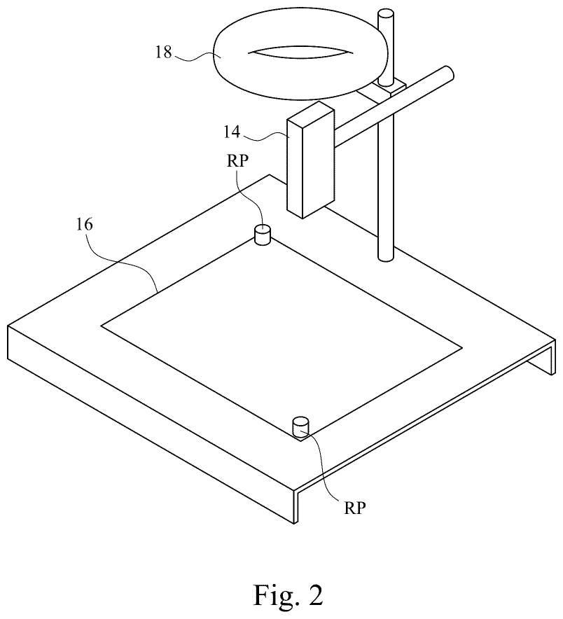

For a specific embodiment of the modeling apparatus 1, please refer to FIG. 2. As shown in the figure, the object can be disposed on a platform (i.e., the placement space) above the backlight source 16 of the modeling apparatus 1, and the camera 14 can capture images in a direction of the backlight source 16. In addition, two reference points RP are provided on the platform above the backlight source 16 to serve as a reference for calculating the size of the object.

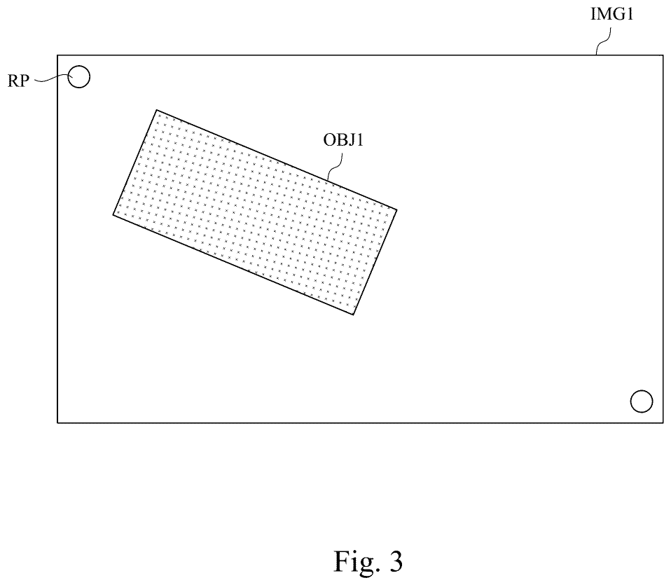

Accordingly, when capturing the first image, the processor 12 is configured to control the backlight source 16 turn on the backlight, and control the camera 14 to capture the first image. Please further refer to FIG. 3, which depicts a schematic diagram of a backlight image IMG1 according to some embodiments of the present disclosure. The backlight image IMG1 includes two reference points RP and an object image OBJ1. By turning on the backlight, the modeling apparatus 1 can capture a high-contrast backlight image IMG1, so that the processor 12 can more accurately capture the contour of the object.

Further, the modeling apparatus 1 is configured to calculate the contour of the object according to the backlight image IMG1, which includes converting the backlight image IMG1 into a grayscale image, calculating an image edge of the grayscale pixels, and then generating the contour of the object according to the image edge.

Specifically, the operation of the processor 12 to capture a contour of the object further includes: calculating a plurality of grayscale values in a plurality of pixels of the first image; calculating an edge of the first image corresponding to the object according to the grayscale values; and generating the contour of the object according to the edge.

In other embodiments, the modeling apparatus 1 can capture the contour of the object in many different ways. For example, the operation of the modeling apparatus 1 to capture the contour of the object from the backlight image IMG1 may also include at least one of the following operations: (1) obtaining a region of interest (ROI) of the object, (2) using a Gaussian filter to reduce noise on the backlight image IMG1, (3) calculating pixel grayscale values and capturing the darkest connected block, (4) reducing the region of interest to extract features, (5) calculating a number of image channels (colors), (6) calculating the image size of the object, (7) generating a grayscale image and filtering it using a channel threshold, (8) merging the three-channel images and calculating the difference between the regions, (9) coloring the pixels in the area, (10) adjusting an image size and performing image superposition, (11) calculating a concatenation superposition of multiple regions, (12) reducing the image definition domain and retain the area of the object, (13) extracting color edges, (14) morphological image processing, closing operation to smooth the contour, (15) finding the connected area, (16) filling the holes in the area, (17) getting a center of the area, (18) filtering the area based on the features to obtain the contour of the object.

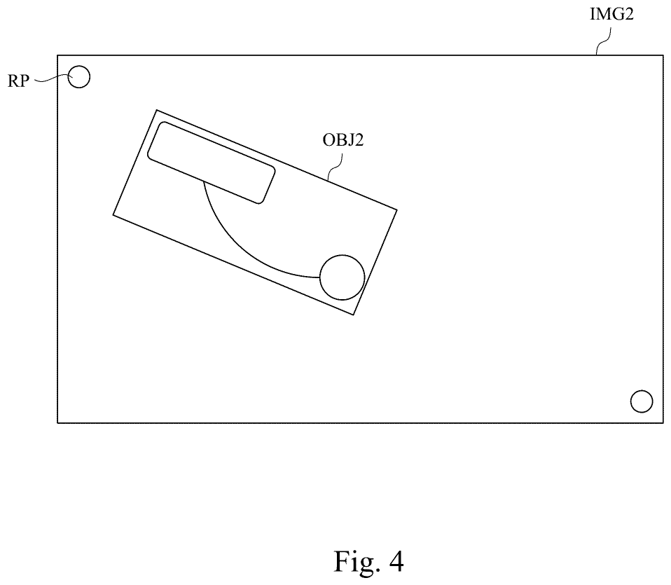

On the other hand, when capturing the second image, the processor 12 is configured to control the positive light source 18 to turn on the fill light, and control the camera 14 to capture the second image. Please further refer to FIG. 4, which depicts a schematic diagram of a fill light image IMG2 according to some embodiments of the present disclosure. The fill light image IMG2 includes two reference points RP and an object image OBJ2. By turning on the fill light, the modeling apparatus 1 can capture the appearance of the object, so that processor 12 can capture a clearer appearance of the object.

In some embodiments, before capturing the fill light image IMG2, the modeling apparatus 1 is configured to determine whether to enable the fill light according to the shooting environment.

Specifically, the operation of capturing the second image of the object further includes: the processor 12 is configured to calculate a surrounding brightness according to a third image captured by the camera 14; and the processor 12 is configured to turn off the positive light source 18 in response to the surrounding brightness being greater than a brightness threshold.

For example, before capturing the second image, camera 14 is configured to capture ambient image first, and the processor 12 is configured to calculate the surrounding brightness. If the surrounding brightness is sufficient, the positive light source 18 is turned off when capturing the second image.

After obtaining the backlight image IMG1 and the fill light image IMG2, the modeling apparatus 1 can capture the appearance of the object from the fill light image IMG2 according to the contour of the object captured form the backlight image IMG1. Since the backlight image IMG1 and the fill light image IMG2 are taken from the same viewing angle, and the object is placed in the same position, the modeling apparatus 1 can directly capture the appearance of the object from the fill light image IMG2 at the position where the contour is captured.

Specifically, the operation of processor 12 to capture the appearance of the object further includes: cropping the second image to capture the appearance of the object according to the contour of the object in the first image.

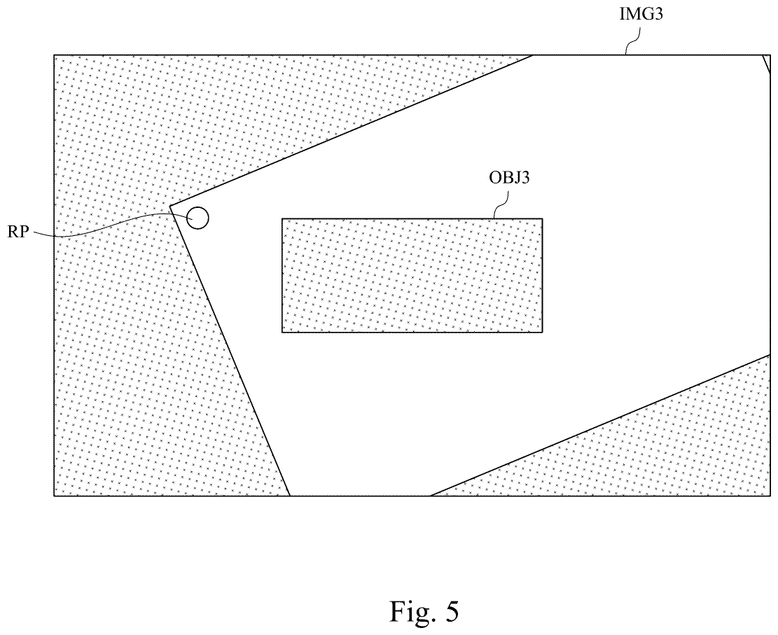

In some embodiments, in order to facilitate subsequent image processing operations, after extracting the contour of the object from the backlight image IMG1, the modeling apparatus 1 is further configured to translate and rotate the backlight image IMG1 to place the object image OBJ1 at the center of the image. Please refer to FIG. 5 for the adjusted backlight image IMG3, where the object image OBJ3 is placed at the center of the backlight image IMG3.

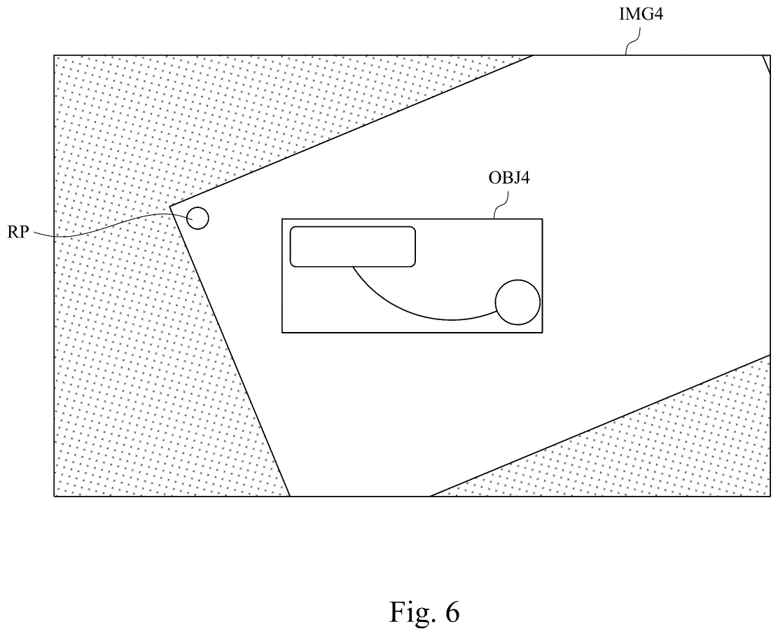

Correspondingly, the modeling apparatus 1 is configured to calculate a transformation matrix for the translation and rotation operations on the backlight image IMG1, and adjust the fill light image IMG2 according to the transformation matrix to perform the same translation and rotation operations. Please refer to FIG. 6 for the adjusted fill light image IMG4, similar to the backlight image IMG3, the object image OBJ4 is placed at the center of the fill light image IMG4.

In this way, based on the adjusted fill light image IMG4, the modeling apparatus 1 can capture the appearance of the object after being adjusted.

Specifically, the operation of the processor 12 to capture the appearance of the object further includes: calculating a transformation matrix according to the contour of the object in the first image; adjusting the second image according to the transformation matrix; and cropping the adjusted second image to capture the appearance of the object according to the contour of the object.

In other embodiments, the modeling apparatus 1 can generate the adjusted backlight image IMG3 in many different ways. For example, the operation of the modeling apparatus 1 adjusting the backlight image IMG1 to obtain the backlight image IMG3 include at least one of the following operations: (1) calculating a minimum enclosing area of a backlight image as a basis for rotation, (2) getting a connected area of a bounding box, (3) calculating an axis of an ellipse in a region to obtain a long side, a short side and direction, (4) getting a regional center, (5) calculating am aspect ratio, (6) generating a circular area and comparing a horizontal degree of an image, (7) creating a unit homogeneous two-dimensional (2D) transformation matrix, (8) calculating rotation parameters of a 2D homogeneous transformation matrix, (9) calculating translation parameters of a 2D homogeneous transformation matrix, (10) performing an affine transformation on the image to a center of the area of the object.

Next, the modeling apparatus 1 is configured to calculate a height of the three-dimensional model based on the depth information obtained by the camera 14.

Specifically, the camera 14 is a depth camera, and the operation of the processor 12 to generate the three-dimensional model of the object further includes: generating a depth information corresponding to the object according to the first image or the second image; and generating the three-dimensional model of the object according to the depth information, the contour, the appearance and the size of the object.

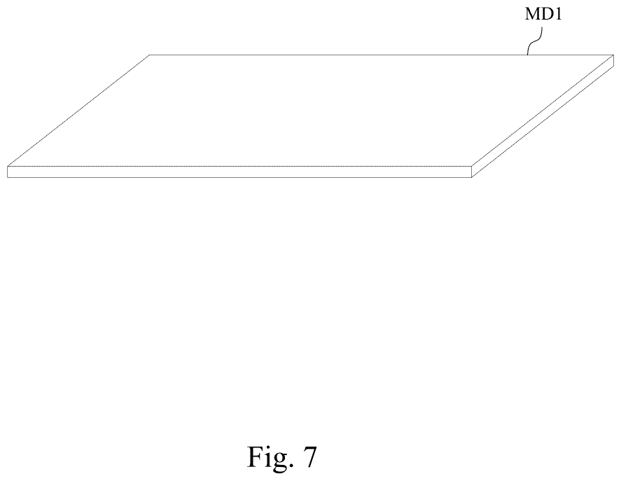

Please refer to FIG. 7, the modeling apparatus 1 is configured to combine the contour and the depth information of the object to generate a three-dimensional model MD1, where the three-dimensional model MD1 has a horizontal shape of the contour of the object and a height of the depth information.

Specifically, the operation of the processor 12 to generate the three-dimensional model of the object further includes: generating a basal plane of the three-dimensional model according to the contour of the object; generating a thicknesses of the three-dimensional model according to the depth information of the object; and constructing the three-dimensional model according to the basal plane and the thicknesses of the three-dimensional model.

It should be noted that the depth information can be obtained from the first image or the second image taken by the depth camera 14, or can also be obtained from other images. In addition, in the embodiment where the camera 14 is a planar camera, the depth information can be obtained by another depth camera, or calculated after obtaining images from multiple cameras with different viewing angles.

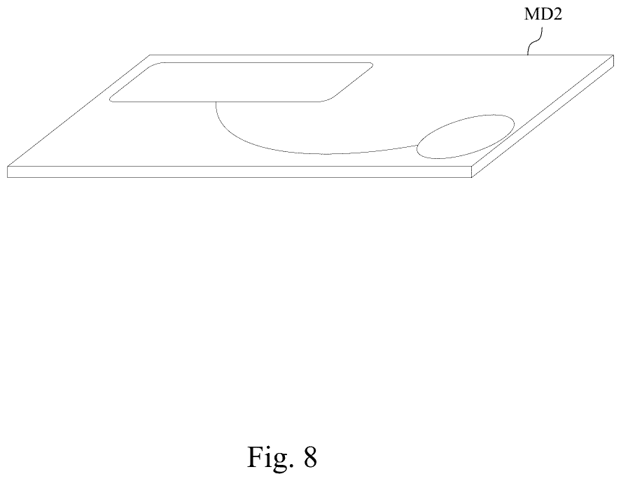

Finally, please refer to FIG. 8, after establishing the three-dimensional model MD1, the modeling apparatus 1 is further configured to combine the three-dimensional model MD1 and the previously obtained appearance of the object to generate a three-dimensional model MD2, where the three-dimensional model MD2 has the appearance of a surface of the object.

In summary, the modeling apparatus 1 proposed in the present disclosure can capture the contour and the appearance of the object, and establish a three-dimensional model of the object through a plurality of images of the object. In addition, based on the images under different light sources, the modeling apparatus 1 can capture the contour of the object more accurately and with a clearer appearance. Accordingly, the modeling apparatus 1 can provide a low-cost, high-efficiency and high-precision modeling technology.

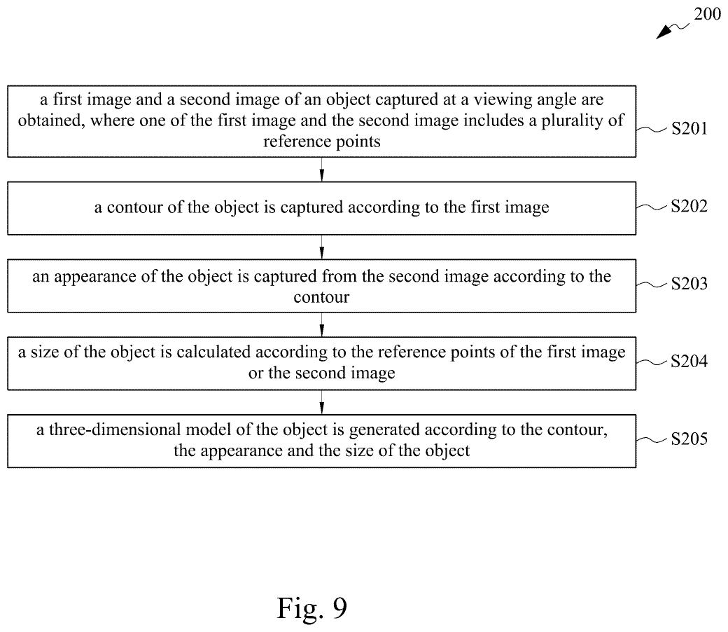

Please refer to FIG. 9, which depicts a flow chart of a modeling method 200 according to a second embodiment of the present disclosure. The modeling method 200 includes steps S201 to S205. The modeling method 200 is configured to establish a three-dimensional model of the object based on images. The modeling method 200 may be executed by an electronic device (e.g.: the modeling apparatus 1 in the firs embodiment).

First, in step S201, the electronic device obtains a first image and a second image of an object captured at a viewing angle, where one of the first image and the second image includes a plurality of reference points.

Next, in step S202, the electronic device captures a contour of the object according to the first image.

Next, in step S203, the electronic device captures an appearance of the object from the second image according to the contour.

Next, in step S204, the electronic device calculates a size of the object according to the reference points of the first image or the second image.

Finally, in step S205, the electronic device generates a three-dimensional model of the object according to the contour, the appearance and the size of the object.

In some embodiments, the step S201 further includes the electronic device turning on a backlight source to project a backlight towards to the viewing angle; and the electronic device capturing the first image of the object when the backlight source projects the backlight.

In some embodiments, the step S201 further includes the electronic device turning on a positive light source to project a fill light towards to the object; and the electronic device capturing the second image of the object when the positive light source projects the fill light.

In some embodiments, the step S201 further includes the electronic device calculating a surrounding brightness according to a third image; and the electronic device turning off the positive light source in response to the surrounding brightness being greater than a brightness threshold.

In some embodiments, the step S202 further includes the electronic device calculating a plurality of grayscale values in a plurality of pixels of the first image; the electronic device calculating an edge of the first image corresponding to the object according to the grayscale values; and the electronic device generating the contour of the object according to the edge.

In some embodiments, the step S203 further includes the electronic device cropping the second image to capture the appearance of the object according to the contour of the object in the first image.

In some embodiments, the step S203 further includes the electronic device calculating a transformation matrix according to the contour of the object in the first image; the electronic device adjusting the second image according to the transformation matrix; and the electronic device cropping the adjusted second image to capture the appearance of the object according to the contour of the object.

In some embodiments, the step S204 further includes the electronic device calculating a pixel distance according to an actual distance between the reference points and a number of pixels between the reference points in the first image or the second image; and the electronic device calculating the size of the object according to the pixel distance.

In some embodiments, the step S205 further includes the electronic device generating a depth information corresponding to the object according to the first image or the second image; and the electronic device generating the three-dimensional model of the object according to the depth information, the contour, the appearance and the size of the object.

In some embodiments, the step S205 further includes the electronic device generating a basal plane of the three-dimensional model according to the contour of the object; the electronic device generating a thicknesses of the three-dimensional model according to the depth information of the object; and the electronic device constructing the three-dimensional model according to the basal plane and the thicknesses of the three-dimensional model.

In summary, the modeling method 200 proposed in the present disclosure can capture the contour and the appearance of the object, and establish a three-dimensional model of the object through a plurality of images of the object. In addition, based on the images under different light sources, the modeling method 200 can capture the contour of the object more accurately and with a clearer appearance. Accordingly, the modeling method 200 can provide a low-cost, high-efficiency and high-precision modeling technology.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A modeling apparatus, comprising:
a camera, configured to capture a first image and a second image of an object at a viewing angle, wherein one of the first image and the second image comprises a plurality of reference points; and
a processor, coupled to the camera, and configured to perform following operations:
capturing a contour of the object according to the first image;
capturing an appearance of the object from the second image according to the contour of the object;
calculating a size of the object according to the reference points of the first image or the second image; and
generating a three-dimensional model of the object according to the contour, the appearance and the size of the object.

2. The modeling apparatus of claim 1, further comprising:
a backlight source, coupled to the processor, and configured to project a backlight towards to the camera, wherein a placement space is formed between the backlight source and the camera, and the placement space is configured to accommodate the object;
wherein the operation of capturing the first image of the object further comprises:
turning on the backlight source to project the backlight by the processor; and
capturing the first image of the object by the camera when the backlight source projects the backlight.

3. The modeling apparatus of claim 1, further comprising:
a positive light source, coupled to the processor, and configured to project a fill light towards to the object;
wherein the operation of capturing the second image of the object further comprises:
turning on the positive light source to project the fill light by the processor; and
capturing the second image of the object by the camera when the positive light source projects the fill light.

4. The modeling apparatus of claim 3, wherein the operation of capturing the second image of the object further comprises:
calculating a surrounding brightness by the processor according to a third image captured by the camera; and
turning off the positive light source by the processor in response to the surrounding brightness being greater than a brightness threshold.

5. The modeling apparatus of claim 1, wherein the operation of capturing the contour of the object further comprises:
calculating a plurality of grayscale values in a plurality of pixels of the first image;
calculating an edge of the first image corresponding to the object according to the grayscale values; and
generating the contour of the object according to the edge.

6. The modeling apparatus of claim 1, wherein the operation of capturing the appearance of the object further comprises:
cropping the second image to capture the appearance of the object according to the contour of the object in the first image.

7. The modeling apparatus of claim 1, wherein the operation of capturing the appearance of the object further comprises:
calculating a transformation matrix according to the contour of the object in the first image;
adjusting the second image according to the transformation matrix; and
cropping the adjusted second image to capture the appearance of the object according to the contour of the object.

8. The modeling apparatus of claim 1, wherein the operation of calculating the size of the object further comprises:
calculating a pixel distance according to an actual distance between the reference points and a number of pixels between the reference points in the first image or the second image; and
calculating the size of the object according to the pixel distance.

9. The modeling apparatus of claim 1, wherein the camera is a depth camera, and the operation of generating a three-dimensional model of the object further comprises:
generating a depth information corresponding to the object according to the first image or the second image; and
generating the three-dimensional model of the object according to the depth information, the contour, the appearance and the size of the object.

10. The modeling apparatus of claim 9, wherein the operation of generating a three-dimensional model of the object further comprises:
generating a basal plane of the three-dimensional model according to the contour of the object;
generating a thicknesses of the three-dimensional model according to the depth information of the object; and
constructing the three-dimensional model according to the basal plane and the thicknesses of the three-dimensional model.

11. A modeling method, adapted to an electronic device, wherein steps of the modeling method comprises:
obtaining a first image and a second image of an object captured at a viewing angle, wherein one of the first image and the second image comprises a plurality of reference points;
capturing a contour of the object according to the first image;
capturing an appearance of the object from the second image according to the contour;
calculating a size of the object according to the reference points of the first image or the second image; and
generating a three-dimensional model of the object according to the contour, the appearance and the size of the object.

12. The modeling method of claim 11, wherein the step of capturing the first image of the object further comprises:
turning on a backlight source to project a backlight towards to the viewing angle; and
capturing the first image of the object when the backlight source projects the backlight.

13. The modeling method of claim 11, wherein the step of capturing the second image of the object further comprises:
turning on a positive light source to project a fill light towards to the object; and
capturing the second image of the object when the positive light source projects the fill light.

14. The modeling method of claim 13, wherein the step of capturing the second image of the object further comprises:
calculating a surrounding brightness according to a third image; and
turning off the positive light source in response to the surrounding brightness being greater than a brightness threshold.

15. The modeling method of claim 11, wherein the step of capturing the contour of the object further comprises:
calculating a plurality of grayscale values in a plurality of pixels of the first image;
calculating an edge of the first image corresponding to the object according to the grayscale values; and
generating the contour of the object according to the edge.

16. The modeling method of claim 11, wherein the step of capturing the appearance of the object further comprises:
cropping the second image to capture the appearance of the object according to the contour of the object in the first image.

17. The modeling method of claim 11, wherein the step of capturing the appearance of the object further comprises:
calculating a transformation matrix according to the contour of the object in the first image;
adjusting the second image according to the transformation matrix; and
cropping the adjusted second image to capture the appearance of the object according to the contour of the object.

18. The modeling method of claim 11, wherein the step of calculating the size of the object further comprises:
calculating a pixel distance according to an actual distance between the reference points and a number of pixels between the reference points in the first image or the second image; and
calculating the size of the object according to the pixel distance.

19. The modeling method of claim 11, wherein the step of generating the three-dimensional model of the object further comprises:
generating a depth information corresponding to the object according to the first image or the second image; and
generating the three-dimensional model of the object according to the depth information, the contour, the appearance and the size of the object.

20. The modeling method of claim 19, wherein the step of generating the three-dimensional model of the object further comprises:
generating a basal plane of the three-dimensional model according to the contour of the object;
generating a thicknesses of the three-dimensional model according to the depth information of the object; and
constructing the three-dimensional model according to the basal plane and the thicknesses of the three-dimensional model.
